(19) United States
(12) Patent Application Publication
(10) Pub. No.: US 2024/0280390 A1
(43) Pub. Date: Aug. 22, 2024

(54) BOOTSTRAPPED IMPEDANCE MEASUREMENT FOR FLOW METER ELECTRODE

(71) Applicant: Micro Motion, Inc., Boulder, CO (US)

(72) Inventors: Bruce David Rovner, Wailuku, HI (US); Kirk Allan Hunter, Eden Prairie, MN (US); Jared James Dreier, Chaska, MN (US); Scot Ronald Foss, Eden Prairie, MN (US); Samuel Ethan Messenger, Chaska, MN (US)

(21) Appl. No.: 18/582,923

(22) Filed: Feb. 21, 2024

Related U.S. Application Data
(60) Provisional application No. 63/486,307, filed on Feb. 22, 2023.

(51) Int. Cl. G01F 1/60; G01F 1/58

(52) U.S. Cl. CPC G01F 1/60; G01F 1/588

(57) ABSTRACT

A magnetic flow meter for measuring flow of a process fluid in a pipe, the flow meter includes a magnetic coil disposed adjacent to the pipe configured to apply a magnetic field to the process fluid. First and second electrodes disposed within the pipe which are electrically coupled to the process fluid and configured to sense an electromotive force (EMF) induced in the process fluid due to the applied magnetic field and flow of the process fluid and responsively provide respective first and second electrode signals. Output circuitry coupled to the first and second electrodes provides an output related to the sensed EMF. Diagnostic circuitry provides an electrode referenced diagnostic signal. A method is also provided.

### CROSS-REFERENCE TO RELATED APPLICATION

The present application is based on and claims the benefit of U.S. provisional patent application Ser. No. 63/486,307, filed Feb. 22, 2023, the content of which is hereby incorporated by reference in its entirety.

### BACKGROUND

The present invention relates to magnetic flow meters of the type used to measure flow of process fluid through process piping. More specifically, the present invention relates to performing diagnostics on electrodes of magnetic flow meters.

Field devices are used in industrial process monitoring and/or control systems to monitor process variables associated with a particular process. Such process variables can include fluid pressure, fluid flow rate, fluid temperature, level, etc.

Magnetic flow meters are a type of field device that are used to measure a fluid flow rate of a conductive process fluid as it flows within a flow tube that is coupled to a pipe. A particular magnetic flow meter includes an electromagnet coil and electrodes. In accordance with Faraday's law of electromagnetic induction, the electromagnet coil is used to apply a magnetic field to the process fluid within the flow tube. The applied magnetic field and movement of the fluid induces an electromotive force (EMF) in the process fluid, which is proportional to the flow rate. The electrodes are positioned in the flow tube to make electrical contact with the flowing process fluid to sense the induced EMF. In a particular embodiment, the EMF is measured by the flow meter using an amplifier connected to the electrodes to amplify the EMF signal, and an analog-to-digital converter (ADC) to quantize the output of the amplifier to produce a data value related to the fluid flow rate.

During operation of the magnetic flow meter, there are a number of conditions which can cause errors in flow measurements performed by the flow meter. Such conditions include the degradation of electrodes used to electrically couple to the process fluid and the quality of the connection of an electrode to the process fluid. One technique to evaluate these conditions uses a ground referenced diagnostic signal. However, there is an ongoing need for improved diagnostics of magnetic flow meters.

### SUMMARY

A magnetic flow meter for measuring flow of a process fluid in a pipe, the flow meter includes a magnetic coil disposed adjacent to the pipe configured to apply a magnetic field to the process fluid. First and second electrodes disposed within the pipe which are electrically coupled to the process fluid and configured to sense an electromotive force (EMF) induced in the process fluid due to the applied magnetic field and flow of the process fluid and responsively provide respective first and second electrode flow signals. Output circuitry coupled to the first and second electrodes provides an output related to the sensed EMF. Diagnostic circuitry provides an electrode referenced diagnostic signal to at least one of the first and second electrodes. A method is also provided.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a partial cut away view of a magnetic flow meter.

FIG. 2 is a simplified electrical schematic diagram of the magnetic flow meter of FIG. 1.

FIG. 3 is a graph of impedances.

FIGS. 4 and 5 are graphs of a diagnostic signal in the form of a high frequency sine wave applied to a low frequency square wave electrode signal.

FIGS. 6 and 7 are simplified block diagrams of electrode diagnostic circuitry, including an electrode referenced diagnostic signal.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. Some elements may not be shown in each of the figures in order to simplify the illustrations.

The various embodiments of the present disclosure may be embodied in many different forms and should not be construed as limited to the specific embodiments set forth herein. Rather, these embodiments are provided so that this disclosure will be thorough and complete, and will fully convey the scope of the present disclosure to those skilled in the art.

In various aspects, the present invention applies a diagnostic signal to the electrodes of a magnetic flow meter in a way that reduces or minimizes the disturbance of the flow signal while enabling diagnostic measurements to be made on the process fluid and the electrical connection of the electrodes to the fluid. An industrial process variable transmitter is provided, which includes circuitry configured to sense an electromotive force (EMF) that is related to the flow of process fluid flowing through process piping and perform diagnostic measurements. In one aspect, the invention provides a configuration in which a diagnostic signal shares the same signal path as an electrode flow signal. This reduces the number of components and space required for additional circuitry such as additional analog switches, and conditioning amplifiers used to provide discrete signal paths.

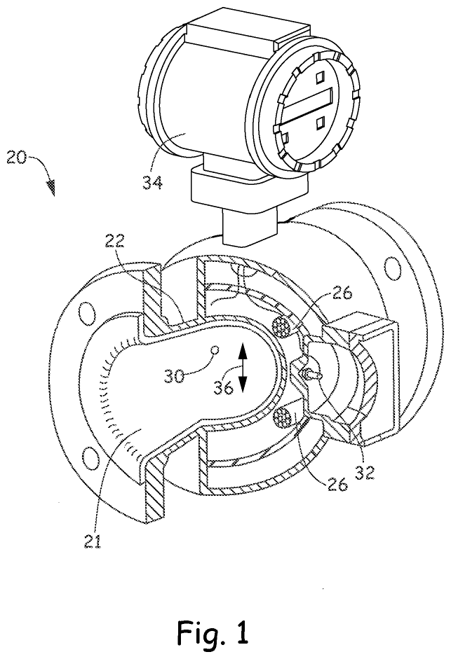

FIG. 1 is a partially cut away view of a magnetic flow meter 20 in which embodiments of the present invention are particularly useful. Magnetic flow meter 20 includes a flow tube 22, an electromagnet (coil) 26 and electrodes 30, 32. The electromagnet coil 26 and the electrodes 30, 32 are wired to transmitter circuitry in housing 34. In operation, the transmitter circuitry drives the electromagnet 26 with an electrical current, and the electromagnet 26 produces a magnetic field 36 indicated by arrows inside the flow tube 22. Process fluid 21 flows through the magnetic field in the flow tube 22, and the flow induces an electromotive force (EMF, voltage) in the liquid 21. The electrodes 30, 32 contact the fluid 21 and pick up or sense the EMF which, according to Faraday's law, is proportional to the flow rate of the liquid 21 in the flow tube 22.

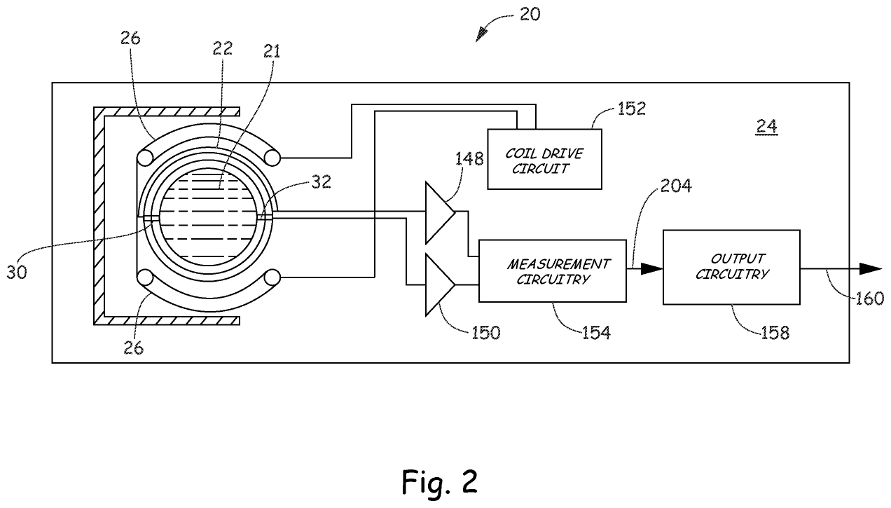

FIG. 2 is a diagrammatic view of transmitter circuitry 24 of magnetic flow meter transmitter 20. The electromagnetic coils 26 are powered by a drive signal from coil drive circuitry 152. Electrodes 30 and 32 provide an electrode voltage signal to measurement circuitry 154 through amplifiers 148 and 150 which is related to flow of process fluid 21. Measurement circuitry 154 provides a measurement output related to flow in accordance with known techniques. Measurement circuitry 154 can include, for example, suitably programmed or configured microprocessor(s) or digital signal processor (DSP) circuitry. Amplifiers 148 and 150 along with measurement circuitry 154 generally provide a “front end” or input circuitry for the magnetic flow meter 20.

The output 204 of measurement circuitry 154 is provided to output circuitry 158 for transmission to control or monitoring circuitry remote from magnetic flow meter 20. However, the output 204 can be transmitted to other locations as desired or used internally by flow meter 20. Output circuitry 158 may provide a pulse output, a 4-20 mA current output, a digital output, a wireless output, or other type of output as desired. In this example, the output of output circuitry 158 is shown coupled to a process control loop 160. A reference connection (not shown in FIG. 1 or 2) can also be provided to the process fluid for use in performing diagnostics.

A high input impedance input connection to the electrodes 30,32 is required to accurately measure the flow using the electrode signals. In order to perform diagnostics, it is desirable to know the impedance of the process fluid 21 and the quality of the connection between the process fluid 21 and the measurement electrodes 30,32. This can be used to detect degradation of the electrodes 30,32, or other conditions. Such diagnostic measurements can be made by applying an electrode diagnostic signal to the electrodes 30,32 and observing the response. However, in typical flow meter configurations, the application of such a diagnostic signal will affect the electrode signals provided by electrodes 30,32 causing errors in the flow measurement. Further, there can be DC offset voltages present between the electrodes. Therefore, it is desirable to AC couple an electrode diagnostic signal to the electrodes 30,32. It is possible to apply the diagnostic signal through an AC coupled current source. However, it is difficult to implement such an AC coupled current source. The AC coupled current source must be designed to maintain a high output impedance while operating over a wide temperature range, with a limited power supply. Tight component tolerances are required to maintain a high output impedance. Further, the high output impedance current signal may attenuate due to cable capacitance and therefore limit the usable frequency range of the diagnostic signal. There is also typically limited space to implement such circuitry.

In one aspect, the invention provides a novel solution for applying an electrode diagnostic signal that uses a buffered electrode input signal as a reference for the diagnostic measurement excitation voltage signal. This allows for the application of the diagnostic signal using a voltage source, while maintaining a high input impedance to the electrode signal. As the diagnostic signal source is referenced to the electrode signal, the diagnostic signal can be applied through a relatively low impedance connection and still remain connected during the flow measurement if desired. The diagnostic signal source can also be connected and disconnected with minimal disturbance to the flow measurement.

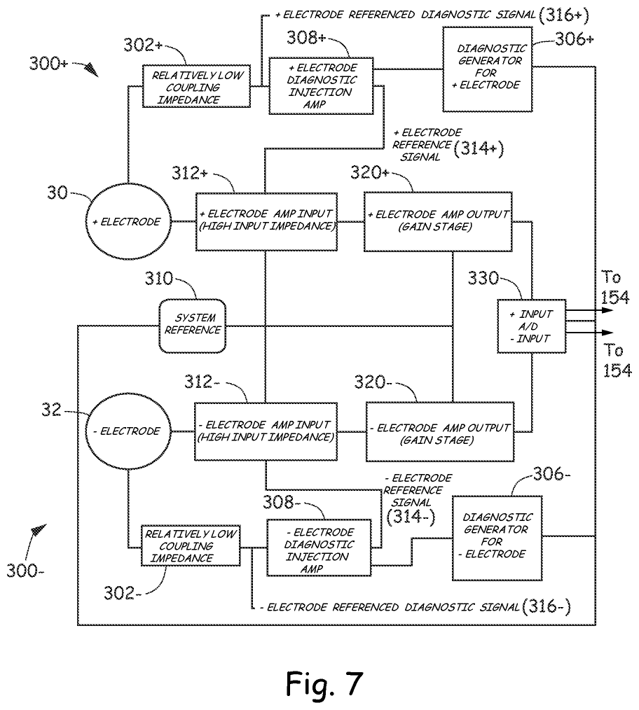

The invention provides a bootstrapped diagnostic signal circuit. (See FIG. 6.) A bootstrapped amplifier 308 is provided for the electrode signal 314. A diagnostic stimulus signal 316 is referenced to the buffered bootstrap signal and driven as desired with diagnostic generator 306. The electrode referenced stimulus signal 316 is coupled to an electrode 30. Any appropriate type of bootstrapped amplifier may be implemented, and the invention is not limited to a particular implementation. However, in one aspect, the implementation uses the buffered electrode input signal as a reference when generating the diagnostic stimulus voltage signal 316.

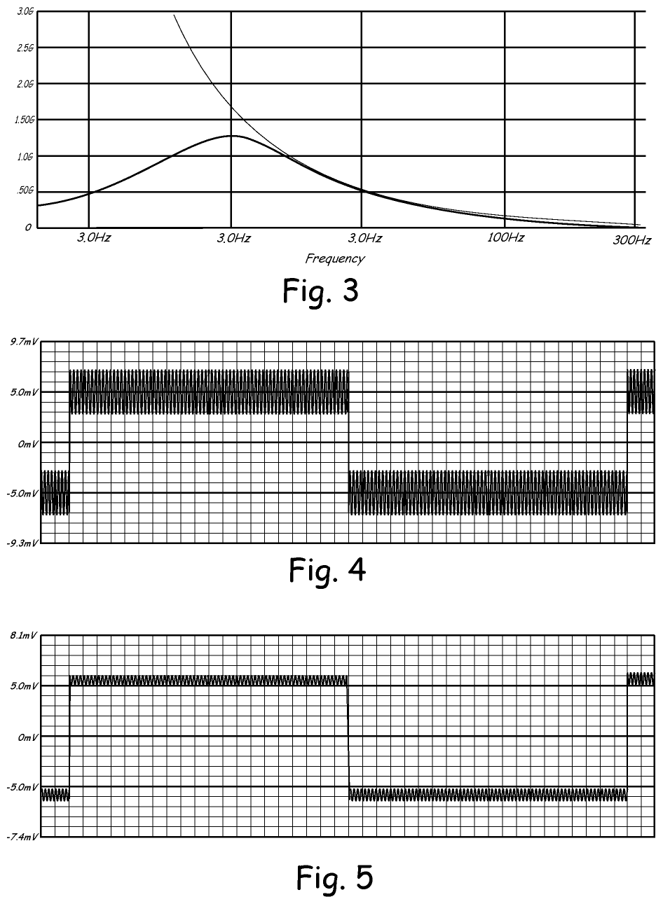

The input impedance of the electrode circuit is shown in FIG. 3. The upper trace represents the input impedance of the diagnostic stimulus connection which is greater than or equal to the lower trace, which represents the input impedance of the electrode amplifier connection throughout the frequency range. If a standard voltage amplifier were used to connect the diagnostic stimulus signal, the upper trace would simply represent the impedance of the series RC value used to connect it.

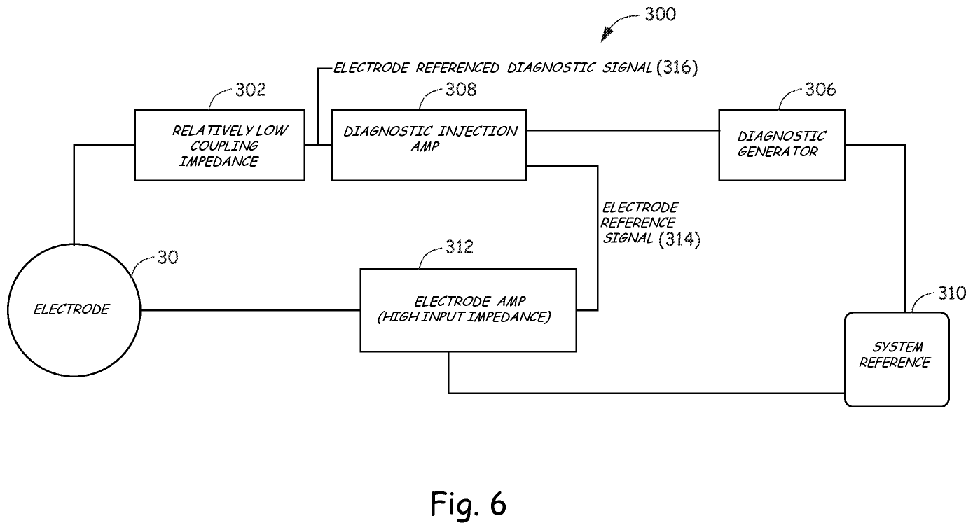

The graphs in FIGS. 4 and 5 show the diagnostic signal (a high frequency sine wave) superimposed on the electrode flow signal (a low frequency square wave) with electrode resistances of 100 k Ohms and 10K Ohms, respectively. These graphs illustrate the ability of the invention to detect changes in electrode impedance while sensing the electrode flow signal. The invention provides a number of features, including:
1. The ability to use a low diagnostic coupling impedance, which allows for the accurate measurement of lower impedance electrode connections.
2. The electrode referenced diagnostic signal is a high impedance signal with respect to the electrode flow signal.
3. The electrode referenced diagnostic signal does not require the diagnostic signal to be disconnected during flow measurements. Therefore, there are no AC coupling capacitors requiring discharging or recharging, which could disturb the electrode flow signal.
4. The electrode referenced diagnostic signal is independent for each of the electrodes because each electrode diagnostic signal is referenced to itself. Therefore, the electrode referenced diagnostic signals can be differential or single ended (common mode when both electrodes diagnostic signals are equal amplitude and in phase).
5. The electrode referenced diagnostic signal can be adapted to different electrode impedances without disturbing the flow signal.

FIG. 6 is a simplified block diagram of a diagnostic system 300 for a single electrode 30 including an electrode referenced diagnostic signal 316. In FIG. 6, the electrode referenced diagnostic signal 316 is shown coupled to the electrode 30 through a relatively low impedance coupling 302. An electrode referenced signal 314 is applied to the bootstrapped diagnostic injection amplifier 308 from a high input impedance electrode amplifier 312, which also connects to electrode 30 and to a system reference 310. The diagnostic signal is provided by a diagnostic signal generator 306 which can be a voltage source and coupled to the electrode 30 using the bootstrapped referenced signal injection amplifier 308 to generate the electrode referenced diagnostic signal 316.

FIG. 7 is a simplified block diagram of one embodiment of the invention showing two independent electrode diagnostic systems 300+ and 300−, one for each electrode 30,32. Similar elements have retained their numbering from FIG. 6 but with plus and minus signs to associate components with the polarity of the respective electrode 30,32. As discussed above, bootstrapped amplifier configurations are used with an electrode reference signal (314+,314−) to provide effective high impedance coupling. In this configuration, different diagnostic signals 316+,316− can be applied to each electrode 30,32. The diagnostic signals provided by diagnostic signal generators 306+,306− can be common mode, differential mode and/or at different frequencies. Further, a diagnostic signal can be single ended and applied independently to an electrode. In one configuration, the system reference 310 is a reference electrode coupled to the process fluid or a direct connection to the flow tube 22 such that flow tube 22 provides an electrical reference for the electrodes 30,32. FIG. 7 illustrates electrode gain stages 320+,320− which amplify the electrode voltage signal and provide it to an analog to digital converter 330. The digital outputs from A/D converter 330 are provided to measurement circuitry 154 for flow measurements and diagnostics.

The particular diagnostics performed using the electrode referenced diagnostic signal can be in accordance with known diagnostic techniques. For example, the amplitude of the diagnostic signal is related to the impedance of the connection to the process fluid and may indicate degradation to the electrodes 30,32. The signal can also indicate an empty pipe condition or material build up. Such diagnostics can be performed by measurement circuitry 154 or at a remote location.

As discussed herein, after extended periods of operation, components of the flow meter can develop coatings which will affect performance of the device. Depending on the process fluid, conductive or non-conductive coatings can form on sense electrodes, reference electrodes, a flow tube lining, or the flow tube itself. With the circuitry of FIG. 7, differential impedance measurements can be obtained between any number of combinations of electrodes, flow tube, flow tube liner, or other components and compared with reference values. If a measured impedance drifts from its reference, this can indicate a conductive or non-conductive coating has been deposited, that an electrical leakage path has formed, that an electrical connection is failing, or that for some other reason electrical characteristics of the flow meter have changed. The differential impedance measurements can be made using common mode measurements or by taking multiple single ended measurements.

Although the present invention has been described with reference to preferred embodiments, workers skilled in the art will recognize that changes may be made in form and detail without departing from the spirit and scope of the invention. In various aspects, diagnostic signals can be applied to multiple electrodes and can be completely independent, common mode, differential mode, single ended, or combinations thereof. As used herein, an electrode signal can comprise multiple signals all present on an electrode. For example, an electrode signal can include an electrode flow signal which relates to the EMF generated by the process fluid moving through a magnetic field, along with the electrode referenced diagnostic signal applied to the electrode as discussed herein.

What is claimed is:

1. A magnetic flow meter for measuring flow of a process fluid in a pipe, the flow meter comprising:
a magnetic coil disposed adjacent to the pipe configured to apply a magnetic field to the process fluid;
first and second electrodes disposed within the pipe which are electrically coupled to the process fluid and configured to sense an electromotive force (EMF) induced in the process fluid due to the applied magnetic field and flow of the process fluid and responsively provide respective first and second electrode flow signals;
output circuitry coupled to the first and second electrodes which provides an output related to the sensed EMF; and
diagnostic circuitry including an electrode referenced diagnostic signal applied to at least one of the first and second electrodes.

2. The magnetic flow meter of claim 1 wherein the electrode referenced diagnostic signal is coupled to an electrode through a voltage source which references a diagnostic signal to the electrode flow signal.

3. The magnetic flow meter of claim 2 including an electrode signal amplifier for use in coupling a diagnostic signal to the electrode flow signal.

4. The magnetic flow meter of claim 3 wherein the electrode flow signal is independent of the electrode referenced diagnostic signal.

5. The magnetic flow meter of claim 3 wherein the electrode flow signal is unaffected by changes in the electrode referenced diagnostic signal.

6. The magnetic flow meter of claim 1 wherein the electrode referenced diagnostic signal is a common mode signal.

7. The magnetic flow meter of claim 1 wherein the electrode referenced diagnostic signal is a differential mode signal.

8. The magnetic flow meter of claim 1 wherein the electrode referenced diagnostic signal is a single ended signal.

9. The magnetic flow meter of claim 2 wherein the diagnostic signal is changed based upon process fluid impedance.

10. The magnetic flow meter of claim 2 wherein the diagnostic signal is changed based upon an electrical connection between an electrode and the process fluid.

11. The magnetic flow meter of claim 1 wherein the diagnostic circuitry provides a second diagnostic signal and wherein one diagnostic signal is a common mode signal and the other diagnostic signal is a differential mode signal for use in providing different diagnostics simultaneously.

12. The magnetic flow meter of claim 1 wherein the diagnostic signal changes based upon changes in an electrical characteristic of the flow meter.

13. The magnetic flow meter of claim 12 wherein the diagnostic signal is related to a differential impedance measured between at least two components of the flow meter.

14. A method for measuring flow of a process fluid in a pipe, comprising:
applying a magnetic field to process fluid flowing through the pipe with a magnetic coil;
sensing an electromotive force (EMF) induced in the pipe due to the applied magnetic field and flow of the process fluid using first and second electrodes and responsively generating first and second electrode flow signals;
measuring the EMF with output circuitry, wherein the measured EMF is indicative of flow of the process fluid; and
performing diagnostics using an electrode referenced diagnostic signal applied to at least one of the first and second electrodes.

15. The method of claim 14 including coupling a diagnostic signal to an electrode through a voltage source which references the diagnostic signal to the electrode signal and thereby maintaining a high input impedance.

16. The method of claim 15 including powering the diagnostic signal on and off while obtaining a flow measurement.

17. The method of claim 15 wherein the diagnostic signal is a common mode signal.

18. The method of claim 15 wherein the diagnostic signal is a differential mode signal.

19. The method of claim 15 wherein the diagnostic signal is a single ended signal.

20. The method of claim 15 including providing a second diagnostic signal and wherein one diagnostic signal is a common mode signal and the other diagnostic signal is a differential mode signal for use in providing different diagnostics simultaneously.
